(19) United States
(12) Patent Application Publication
(10) Pub. No.: US 2025/0323560 A1
(43) Pub. Date: Oct. 16, 2025

(54) VOICE COIL MOTOR, ELECTRONIC DEVICE, AND OPTICAL PATH CHANGING DEVICE

(71) Applicant: SEIKO EPSON CORPORATION, Tokyo (JP)

(72) Inventor: Shinichi WAKABAYASHI, SUWA-SHI (JP)

(21) Appl. No.: 19/174,110

(22) Filed: Apr. 9, 2025

(30) Foreign Application Priority Data
Apr. 10, 2024 (JP) 2024-063202

(51) Int. Cl. H02K 41/035; G02B 7/02; H02K 1/34; H02K 3/04

(52) U.S. Cl. CPC H02K 41/0356; H02K 1/34; H02K 3/04; G02B 7/023

(57) ABSTRACT

A voice coil motor includes a coil section having a wound wire and a magnet section configured to contact with the coil section, wherein a member of one of the coil section and the magnet section is configured to move relative to the other member.

The present application is based on, and claims priority from JP Application Serial Number 2024-063202, filed Apr. 10, 2024, the disclosure of which is hereby incorporated by reference herein in its entirety.

### BACKGROUND

### 1. Technical Field

The present disclosure relates to a voice coil motor, an electronic device, and an optical path changing device.

### 2. Related Art

In the related art, an electronic device including a voice coil motor as an actuator is known. As an example of such an electronic device, a disk drive device is known (for example, JP-A-2007-179599).

In the disk drive device described in JP-A-2007-179599, the voice coil motor is configured by a pair of VCM magnets and a VCM coil disposed between the pair of VCM magnets. A swing arm provided with the VCM coil pivots around a pivot shaft by electromagnetic force generated by the interaction between the electric field generated when the VCM coil is energized and the magnetic field of the pair of VCM magnets. As a result, a head provided on the swing arm is moved onto a recording disk medium.

However, in the voice coil motor of the disk drive device described in JP-A-2007 179599, each of the pair of VCM magnets and the VCM coil are provided so as to be separated from each other. That is, in the voice coil motor described in JP-A-2007 179599, the magnet and the coil are not in contact with each other. This causes a problem in that the magnetic efficiency of the voice coil motor is low, making it difficult to increase the thrust of a moving member that moves relative to one of the coil and the magnet.

For this reason, there has been a demand for a voice coil motor configuration that can improve magnetic efficiency.

### SUMMARY

A voice coil motor in according to a first aspect of the present disclosure includes a coil section having a wound wire and a magnet section configured to contact the coil section, wherein a member of one of the coil section and the magnet section is configured to move relative to the other member.

An electronic device according to a second aspect of the present disclosure includes an actuator comprising the voice coil motor according to the first aspect.

An optical path changing device according to a third aspect of the present disclosure includes a movable frame configured to hold an optical path changing member; a support frame configured to support the movable frame via a swing axis; and the voice coil motor according to the first aspect configured to cause the movable frame to swing around the swing axis with respect to the support frame, wherein the coil section is disposed on one of the movable frame and the support frame and the magnet section is disposed on an other of the movable frame and the support frame.

An electronic device according to a fourth aspect of the present disclosure includes a light source device and the optical path changing device according to the third aspect configured to change an optical path of a light flux emitted from the light source device.

### BRIEF DESCRIPTION OF THE DRAWINGS

FIG. 1 is a schematic view showing a voice coil motor included in an actuator according to a first embodiment.

FIG. 2 is a schematic view showing a voice coil motor included in an actuator according to a second embodiment.

FIG. 3 is a schematic view showing a voice coil motor included in an actuator according to a third embodiment.

FIG. 4 is a schematic view showing a voice coil motor included in an actuator according to a fourth embodiment.

FIG. 5 is a schematic view showing a voice coil motor included in an actuator according to a fifth embodiment.

FIG. 6 is a schematic view showing a configuration of a projector according to a sixth embodiment.

FIG. 7 is a view of an optical path changing device according to the sixth embodiment as viewed from a light emitting side.

FIG. 8 is a view for explaining an optical path shift of image light by the optical path changing device according to the sixth embodiment.

### DESCRIPTION OF EMBODIMENTS

### First Embodiment

Hereinafter, a first embodiment of the present disclosure will be described with reference to the drawings.

### Configuration of Actuator and Voice Coil Motor

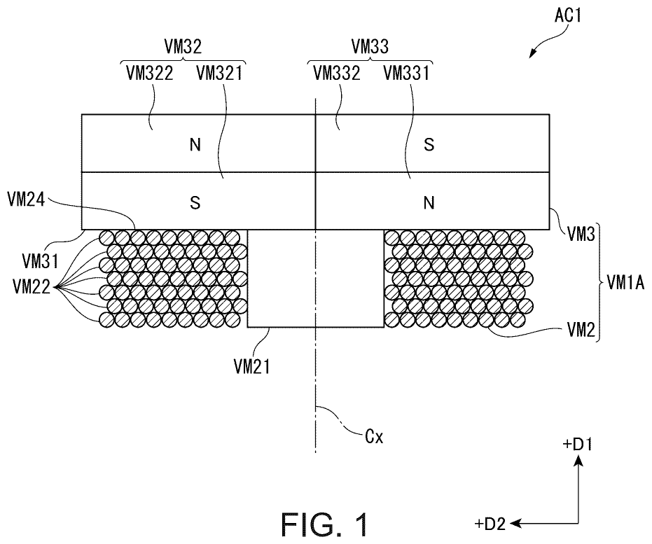

FIG. 1 is a schematic view showing a voice coil motor VM1A included in an actuator AC1 according to the present embodiment.

As shown in FIG. 1, the actuator AC1 according to the present embodiment includes a voice coil motor VM1A having a coil section VM2 and a magnet section VM3.

The voice coil motor VM1A is an actuator that obtains power by supplying an alternating current to the coil section VM2, causing the member of one of the coil section VM2 and the magnet section VM3 to reciprocally move relative to the other member. In the example of FIG. 1, the coil section VM2 is fixed, and the magnet section VM3, which is the member of one of the coil section VM2 and the magnet section VM3, reciprocally moves relative to the coil section VM2, which is the other member.

The coil section VM2 and the magnet section VM3 are in contact with each other and, in the present embodiment, the magnet section VM3 reciprocally moves along a contact surface between the coil section VM2 and the magnet section VM3 in a state of being in contact with the coil section VM2.

Hereinafter, configuration of the voice coil motor VM1A will be described in detail.

### Configuration of Coil Section

The coil section VM2 generates a magnetic field by the alternating current supplied from the outside and generates a thrust for the reciprocal motion of the one member by interacting with the magnet section VM3. The coil section VM2 has a coil bobbin VM21 and a wire VM22.

The coil bobbin VM21 is a cylindrical body around which the wire VM22 is wound along an outer periphery.

The wire VM22 is formed by a conductive material such as copper and is wound along the outer peripheral surface of the coil bobbin VM21. The wire VM22 is connected to a power supply device (not shown) and the alternating current is supplied to the wire VM22.

The coil section VM2 has a contact surface VM24 that is in contact with the magnet section VM3.

The contact surface VM24 is a surface of the coil bobbin VM21 and the wire VM22 facing the magnet section VM3, and corresponds to a coil section side contact surface. The contact surface VM24 is in contact with a contact surface VM31 (to be described later) of the magnet section VM3. That is, the contact surface VM24 is a surface that is configured by at least one of the coil bobbin VM21 and the wire VM22, and is orthogonal to a central axis Cx of the tubular coil bobbin VM21. Note that the central axis Cx of the coil bobbin VM21 coincide with a central axis Cx of the coil section VM2.

### Configuration of Magnet Section

The magnet section VM3 is disposed so as to be opposed to the contact surface VM24 of the coil section VM2, and interacts with the magnetic field generated in the coil section VM2. The magnet section VM3 has the contact surface VM31 that is in contact with the contact surface VM24. The contact surface VM31 corresponds to the magnet section side contact surface. In addition, the magnet section VM3 has a first magnet VM32 and a second magnet VM33 disposed adjacent to the magnet section VM3 in a direction in which the magnet section VM3 moves relative to the coil section VM2.

Note that in the following description, the direction from the coil section VM2 toward the magnet section VM3 along the central axis Cx of the coil section VM2 is referred to as the +D1 direction, and a direction orthogonal to the +D1 direction is referred to as the +D2 direction. Although omitted from the drawings, a direction opposite to the +D1 direction is defined as a −D1 direction, and a direction opposite to the +D2 direction is defined as a −D2 direction.

The first magnet VM32 and the second magnet VM33 have different magnetic poles on the contact surface VM31 that is in contact with the coil section VM2, and are integrated to configure the magnet section VM3.

In the first magnet VM32, the magnetic pole of a first portion VM321 facing the contact surface VM24 is different from the magnetic pole of a second portion VM322, which is on the opposite side of the first portion VM321 than the coil section VM2. In the example of FIG. 1, the magnetic pole of the first portion VM321 is the S pole, and the magnetic pole of the second portion VM322 is the N pole.

The second magnet VM33 is disposed in the −D2 direction with respect to the first magnet VM32. That is, the first magnet VM32 and the second magnet VM33 are disposed adjacent to each other in the +D2 direction.

In the second magnet VM33, the magnetic pole of a first portion VM331 facing the contact surface VM24 is different from the magnetic pole of a second portion VM332, which is on the opposite side of the first portion VM331 than the coil section VM2. The magnetic pole of the first portion VM331 is different from the magnetic pole of the first portion VM321 of the first magnet VM32 and the magnetic pole of the second portion VM332 is different from the magnetic pole of the second portion VM322 of the first magnet VM32. In the example of FIG. 1, the magnetic pole of the first portion VM331 is the N pole, and the magnetic pole of the second portion VM332 is the S pole.

In each of the magnets VM32 and VM33, a surface facing the contact surface VM24 configures the contact surface VM31. That is, both the surface facing the contact surface VM24 in the first portion VM321 of the first magnet VM32 and the surface facing the contact surface VM24 in the first portion VM331 of the second magnet VM33 configure the contact surface VM31. Then, the magnetic poles of the surface in contact with the contact surface VM24 of the coil section VM2 in the first magnet VM32 and the magnetic poles of the surface in contact with the contact surface VM24 in the second magnet VM33 are different from each other.

### Operation of Voice Coil Motor

In the voice coil motor VM1A, when an alternating current is supplied to the coil section VM2, the magnet section VM3, which is not fixed, reciprocally moves in the +D2 directions, which are directions orthogonal to the central axis Cx of the coil section VM2. At this time, the magnet section VM3 reciprocally moves in the +D2 directions while the contact surface VM31 is in contact with the contact surface VM24 of the coil section VM2 in the +D1 direction. This makes it possible to improve the magnetic efficiency of the voice coil motor VM1A.

### Effects of First Embodiment

The actuator AC1 according to the present embodiment described above has the following effects.

The actuator AC1 includes a voice coil motor VM1A.

The voice coil motor VM1A includes the coil section VM2 around which the wire VM22 is wound and the magnet section VM3, which is in contact with the coil section VM2. A member of one of the coil section VM2 and the magnet section VM3 is configured to move relative to the other member. In the present embodiment, the magnet section VM3 moves relative to the coil section VM2.

According to such a configuration, since the coil section VM2 and the magnet section VM3 are in contact with each other, the magnetic efficiency of the voice coil motor VM1A can be improved as compared with a case where the coil section VM2 and the magnet section VM3 are always separated from each other. As a result, the Lorentz force in the voice coil motor VM1A can be increased, and the thrust of the magnet section VM3, which moves relative to the coil section VM2, among the coil section VM2 and the magnet section VM3 can be increased. On the other hand, when the thrust is the same, the voice coil motor VM1A can be made smaller than the voice coil motor of the related art.

In the voice coil motor VM1A, the magnet section VM3 moves relative to the coil section VM2 in the +D2 directions, which are orthogonal to the central axis Cx of the coil section VM2. The magnet section VM3 has a first magnet VM32 and a second magnet VM33 with different magnetic poles at the contact surface, which is in contact with the coil section VM2. That is, the magnetic poles of the surface in contact with the contact surface VM24 of the coil section VM2 in the first magnet VM32 and the magnetic poles of the surface in contact with the contact surface VM24 in the second magnet VM33 are different from each other. The first magnet VM32 and the second magnet VM33 are disposed adjacent to each other in the #D2 directions in which the magnet section VM3 moves relative to the coil section VM2.

According to such a configuration, it is possible to reciprocally move the magnet section VM3 along the +D2 direction perpendicular to the central axis Cx of the coil section VM2. Therefore, it is possible to stably operate the voice coil motor VM1A.

### Second Embodiment

Next, a second embodiment of the present disclosure will be described.

The actuator according to the present embodiment includes the same configuration as the actuator AC1 according to the first embodiment, but differs in that the coil section and the magnet section are provided with a coating for enhancing the sliding property. Note that in the following description, the same or substantially the same parts as those described above are denoted by the same reference symbols and the description thereof will be omitted.

### Configuration of Actuator and Voice Coil Motor

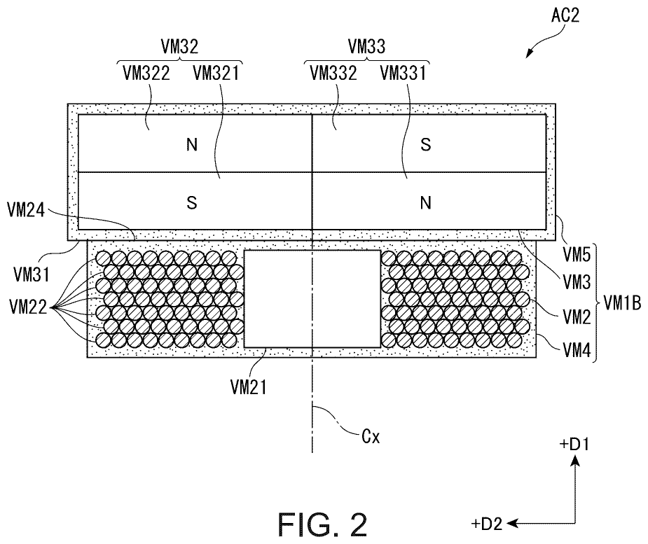

FIG. 2 is a schematic view showing the configuration of an actuator AC2 according to the present embodiment.

The actuator AC2 according to the present embodiment includes a voice coil motor VM1B and functions in the same manner as the actuator AC1 according to the first embodiment.

The voice coil motor VM1B has the same configuration and function as the voice coil motor VM1A according to the first embodiment, except that the voice coil motor VM1B further includes coating layers VM4 and VM5. That is, the voice coil motor VM1B includes the coil section VM2, the magnet section VM3, and the coating layers VM4 and VM5.

### Configuration of Coating Layers

The coating layer VM4 is formed on the outer surface of the coil section VM2 using a coating agent having a low friction coefficient and high wear resistance properties. That is, in the present embodiment, the outer surface of the coil section VM2 is coated with the coating agent.

Examples of such a coating agent include a coating agent containing at least one of polytetrafluoroethylene resin, molybdenum disulfide, carbon graphite, or boron nitride.

In the present embodiment, the coating layer VM4 is formed on substantially the entire outer surface of the coil section VM2 including the contact surface VM24. However, it is not limited to this, and the coating layer VM4 may be formed at least on the contact surface VM24.

The coating layer VM5 is formed on the outer surface of the magnet section VM3 using a coating agent similar to the coating agent that forms the coating layer VM4. That is, in the present embodiment, the outer surface of the magnet section VM3 is coated with the coating agent.

In the present embodiment, the coating layer VM5 is formed on substantially the entire outer surface of the magnet section VM3 including the contact surface VM31. However, it is not limited to this, and the coating layer VM5 may be formed at least on the contact surface VM31.

### Effects of Second Embodiment

The actuator AC2 according to the present embodiment described above has the following effects in addition to the same effects as the actuator AC1 according to the first embodiment.

The actuator AC2 includes the voice coil motor VM1B.

In the voice coil motor VM1B, the coil section VM2 has a contact surface VM24 corresponding to the coil section side contact surface. The magnet section VM3 has the contact surface VM31 that is in contact with the contact surface VM24. The contact surface VM31 corresponds to the magnet section side contact surface.

The contact surface of at least one of the contact surface VM24 and the contact surface VM31 is coated with the coating agent. In the present embodiment, the contact surface VM24 and the contact surface VM31 are each coated with the coating agent.

According to such a configuration, it is possible to reduce the sliding resistance when the magnet section VM3 slides relative to the coil section VM2. Therefore, the magnet section VM3 can be easily slid with respect to the coil section VM2.

Note that the contact surface of only one of the contact surface VM24 and the contact surface VM31 may be coated with the coating agent. The composition of the coating agent coating the contact surface VM24 and the composition of the coating agent covering the contact surface VM31 may be different from each other.

In the voice coil motor VM1B, the coating agent includes at least one of polytetrafluoroethylene resin, molybdenum disulfide, carbon graphite, or boron nitride.

Here, the coating agent containing at least one of fluorine resin, molybdenum disulfide, carbon graphite, or boron nitride is a coating agent with a low friction coefficient and high wear resistance properties.

Therefore, according to the above configuration, it is possible to impart a low friction coefficient and high wear resistance properties to the contact surfaces VM24 and VM31 coated with the coating agent.

### First Modification of Second Embodiment

In the above described second embodiment, the coating agent coating the coil section VM2 covers substantially the entire outer surface of the coil section VM2. However, it is not limited to this, and the coating agent may coat the outer peripheral surface of the wire VM22 of the coil section VM2, so that the coating layer VM4 is formed on the outer peripheral surface of the wire VM22.

By forming the contact surface VM24 using the wire VM22 coated with such a coating agent, a member of one of the coil section VM2 and the magnet section VM3 can easily slide along the contact surface of the other member.

According to such a configuration, in addition to the same effects as the actuator AC2 according to the second embodiment, the following effects can be achieved.

That is, the coating agent coats the outer peripheral surface of the wire VM22.

According to such a configuration, it is not necessary to coat the contact surface VM24 by applying a coating agent to the contact surface VM24 or the like. Therefore, the manufacturing process of the voice coil motor VM1B can be simplified.

### Second Modification of Second Embodiment

In the above described second embodiment, the coating layer VM4 formed by the coating agent is laminated on the coil section VM2 and the coating layer VM5 formed by the coating agent is laminated on the magnet section VM3. However, it is not limited to this, and the coating layer of one of the coating layers VM4 and VM5 may be omitted. That is, a member of one of the coil section VM2 and the magnet section VM3 may not be coated with the coating agent.

### Third Embodiment

Next, a third embodiment of the present disclosure will be described.

The actuator according to the present embodiment includes the same configuration as the actuator AC1 according to the first embodiment, but differs in that the magnet section is subjected to plating processing. Note that in the following description, the same or substantially the same parts as those described above are denoted by the same reference symbols and the description thereof will be omitted.

### Configuration of Actuator and Voice Coil Motor

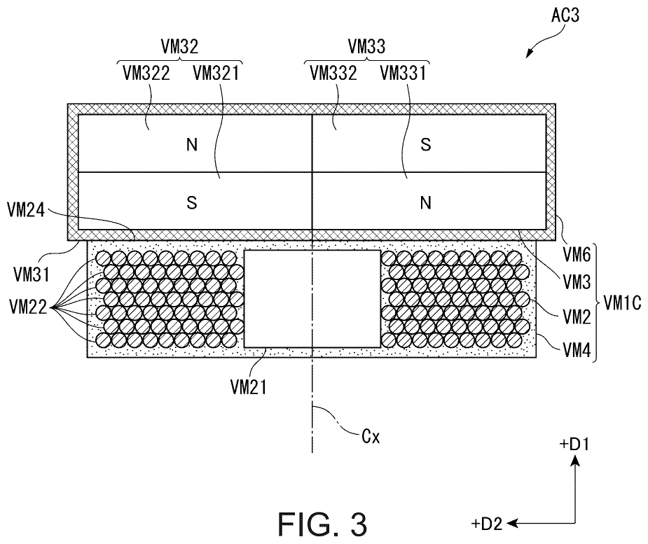

FIG. 3 is a schematic view showing the configuration of an actuator AC3 according to the present embodiment.

The actuator AC3 according to the present embodiment includes a voice coil motor VM1C and functions in the same manner as the actuator AC1 according to the first embodiment.

The voice coil motor VM1C includes the same configuration and function as the voice coil motor VM1B according to the second embodiment, except that a plating layer VM6 is provided instead of the coating layer VM5. That is, the voice coil motor VM1C includes the coil section VM2, the magnet section VM3, the coating layer VM4, and the plating layer VM6.

### Configuration of Plating Layer

The plating layer VM6 is formed on the outer surface of the magnet section VM3 including the contact surface VM31. In other words, the contact surface VM31 is subjected to plating processing. Examples of such plating processing include plating processing with a material containing at least one of nickel, copper, or tin. Note that the plating layer VM6 may be formed only on the contact surface VM31.

### Effects of Third Embodiment

The actuator AC3 according to the present embodiment described above has the following effects in addition to the same effects as the actuator AC2 according to the second embodiment.

The actuator AC3 includes the voice coil motor VM1C.

In the voice coil motor VM1C, the magnet section VM3 has a contact surface VM31 that is in contact with the contact surface VM24 of the coil section VM2. The contact surface VM31 corresponds to the magnet section side contact surface.

The contact surface VM31 is subjected to plating processing with a material containing at least one of nickel, copper, or tin.

According to such a configuration, high lubricity can be imparted by permeating the lubricant into the contact surface VM31 that was subjected to the plating processing. Therefore, the sliding property of the magnet section VM3 with respect to the coil section VM2 can be improved.

### Fourth Embodiment

Next, a fourth embodiment of the present disclosure will be described.

The actuator according to the present embodiment includes the same configuration as the actuator AC1 according to the first embodiment, but differs in that the contact surface of at least one of the coil section and the magnet section is formed of a contacted member made from resin. Note that in the following description, the same or substantially the same parts as those described above are denoted by the same reference symbols and the description thereof will be omitted.

### Configuration of Actuator and Voice Coil Motor

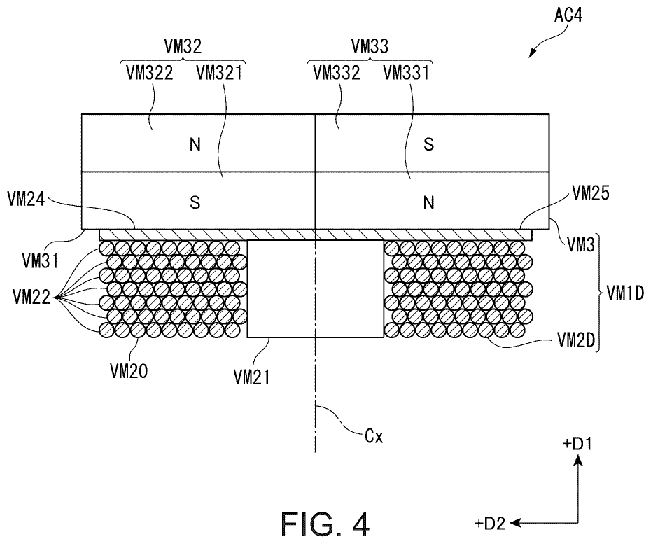

FIG. 4 is a schematic view showing the configuration of an actuator AC4 according to the present embodiment.

The actuator AC4 according to the present embodiment includes a voice coil motor VM1D and functions in the same manner as the actuator AC1 according to the first embodiment.

The voice coil motor VM1D includes a coil section VM2D and the magnet section VM3. Note that the voice coil motor VM1D may be provided with the coating layer VM5 or the plating layer VM6 coating the magnet section VM3.

### Configuration of Coil Section

The coil section VM2D has the same configuration as the coil section VM2 according to the first embodiment and further includes a contacted member VM25. That is, the coil section VM2D has the coil bobbin VM21, the wire VM22, and the contact surface VM24, and further has the contacted member VM25. Note that a member configured by the coil bobbin VM21 and the wire VM22 is referred to as a coil section main body VM20 and the contact surface VM24 is a surface of the coil section main body VM20 with which the contact surface VM31 of the magnet section VM3 is in contact.

The contacted member VM25 is formed of a resin having good self-lubricating properties and wear resistance properties and is provided on a surface of the coil section main body VM20 facing the magnet section VM3. That is, the contact surface VM24 of the coil section VM2D is configured by the contacted member VM25. Examples of the resin forming such as the contacted member VM25 include resins containing polyacetal, polytetrafluoroethylene resin, ultra-high molecular weight polyethylene, monomer cast nylon, and polyacetal resin.

In the present embodiment, the contacted member VM25 configures the coil section VM2D. However, it is not limited to this, and the magnet section may be configured to have a contacted member having the same configuration as that of the contacted member VM25.

In this case, when a member configured by the first magnet VM32 and the second magnet VM33 included in the magnet section is assumed to be a main body section, the contacted member is provided on a surface of the main body section facing the coil section. The contact surface VM31 of the magnet section is configured by the contacted member. Note that when the coil section does not include the contacted member VM25, the coating layer VM4 may be provided to coat the coil section.

### Effects of Fourth Embodiment

The actuator AC4 according to the present embodiment described above has the following effects in addition to the same effects as the actuator AC1 according to the first embodiment.

The actuator AC4 includes a voice coil motor VM1D.

In the voice coil motor VM1D, the coil section VM2 has a contact surface VM24 as the coil section side contact surface and the magnet section VM3 has the contact surface VM31 in contact with the contact surface VM24. The contact surface VM31 corresponds to the magnet section side contact surface.

The contact surface of at least one of the contact surface VM24 and the contact surface VM31 is configured by the contacted member with which the other contact surface is in contact. Specifically, the contact surface VM24 is configured by the contacted member VM25.

According to such a configuration, the sliding property of the magnet section VM3 relative to the coil section VM2 can be increased by configuring the contacted member VM25 with a material having a high sliding property. Therefore, the sliding property of the magnet section VM3 with respect to the coil section VM2 can be improved.

In the voice coil motor VM1D, the contacted member VM25 includes at least one of polyacetal, polytetrafluoroethylene resin, ultra-high molecular weight polyethylene, monomer cast nylon, or polyacetal resin.

Here, polyacetal, polytetrafluoroethylene resin, ultra high molecular weight polyethylene, monomer cast nylon, and polyacetal resin are resins having good self-lubricating properties and wear resistance properties.

By forming the contacted member VM25 from such a resin, it is possible to impart good self-lubricating properties and wear resistance properties to the contact surface VM24.

### Fifth Embodiment

Next, a fifth embodiment of the present disclosure will be described.

The actuator according to the present embodiment includes the same configuration as the actuator AC1 according to the first embodiment, except that the shape of the actuator according to the present embodiment and the shape of actuator AC1 according to the first embodiment are different. Note that in the following description, the same or substantially the same parts as those described above are denoted by the same reference symbols and the description thereof will be omitted.

### Configuration of Actuator and Voice Coil Motor

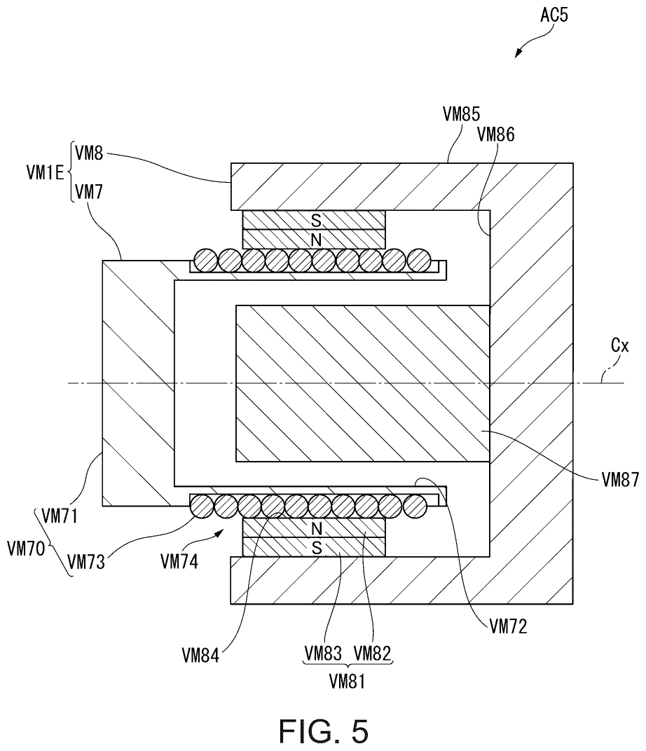

FIG. 5 is a sectional view schematically showing the configuration of an actuator AC5 according to the present embodiment.

As shown in FIG. 5, the actuator AC5 according to the present embodiment includes a voice coil motor VM1E and functions in the same manner as the actuator AC1 according to the first embodiment.

The voice coil motor VM1E includes a coil section VM7 and a magnet section VM8. The voice coil motor VM1E is configured in a columnar shape, unlike the voice coil motors VM1A, VM1B, VM1C, and VM1D.

Hereinafter, the coil section VM7 and the magnet section VM8, which configures the voice coil motor VM1E, will be described.

### Configuration of Coil Section

The coil section VM7 includes a coil bobbin VM71 and a wire VM73.

The coil bobbin VM71 is formed in a bottomed cylindrical shape. The coil bobbin VM71 has an insertion port VM72, which opens at an end portion in the +D1 direction along the central axis Cx of the coil bobbin VM71. A part of a yoke VM87 of the magnet section VM8 is inserted into the insertion port VM72 in the −D1 direction.

The wire VM73 is wound around the outer peripheral surface of the coil bobbin VM71 and configures a coil section main body VM70 of the coil section VM7. The outer peripheral surface of the wire VM73 configures a contact surface VM74 of the coil section VM7. The contact surface VM74 is in contact with the contact surface VM84 of the magnet section VM8. Note that the contact surface VM74 corresponds to the coil section side contact surface.

### Configuration of Magnet Section

The magnet section VM8 is configured in a cylindrical shape disposed along the circumferential direction around the central axis Cx of the coil bobbin VM71. The magnet section VM8 includes a magnet VM81, a support member VM85 for supporting the magnet VM81, and the yoke VM87 provided on the support member VM85.

The magnet VM81 is configured in a ring shape to surround the coil section main body VM70 and is disposed outside the coil section main body VM70 around the central axis Cx of the coil bobbin VM71.

The magnet VM81 has a first portion VM82 facing the contact surface VM74 and a second portion VM83 on the side opposite of the first portion VM82 than the coil section VM7. The magnetic pole of the first portion VM82 and the magnetic pole of the second portion VM83 are different from each other, and in the example of FIG. 5, the magnetic pole of the first portion VM82 is N pole and the magnetic pole of the second portion VM83 is S pole.

The inner peripheral surface of the first portion VM82 configures a contact surface VM84 in contact with the contact surface VM74, which is the outer peripheral surface of the coil section main body VM70. The contact surface VM84 corresponds to the magnet section side contact surface.

The support member VM85 is formed in a bottomed cylindrical shape and supports the outer peripheral surface of the magnet VM81 on its inner peripheral surface, thereby supporting the magnet VM81. In the present embodiment, the support member VM85 is a fixed end fixed to a predetermined member.

The yoke VM87 has a function of aligning the direction of the magnetic flux generated in the magnet section VM8 and increasing the magnetic force of the magnet section VM8. The yoke VM87 is provided so as to protrude in the −D1 direction from the bottom section VM86 of the support member VM85. The yoke VM87 is formed in a columnar shape. When the coil section VM7 and the magnet section VM8 are assembled, a part of the yoke VM87 is inserted into the insertion port VM72 provided in the coil bobbin VM71.

### Operation of Voice Coil Motor

In the voice coil motor VM1E, when the alternating current is supplied to the coil section VM7, the coil section VM7, which is not fixed, reciprocally moves in the +D1 directions along the central axis Cx of the coil section VM7. At this time, the coil section VM7 reciprocally moves in the +D1 directions in a state where the contact surface VM74 is in contact with the contact surface VM84 of the magnet section VM8. This makes it possible to improve the magnetic efficiency of the voice coil motor VM1E.

In the voice coil motor VM1E, the support member VM85 of the magnet section VM8 is fixed and the coil section VM7 moves while being in contact with the magnet section VM8. However, it is not limited to this, and the coil bobbin VM71 may be fixed, and the magnet section VM8 may move while being in contact with the coil section VM7.

### Effects of Fifth Embodiment

The actuator AC5 according to the present embodiment described above has the following effects in addition to the same effects as the actuator AC1 according to the first embodiment.

The actuator AC5 includes the voice coil motor VM1E having the coil section VM7 and the magnet section VM8.

In the voice coil motor VM1E, the coil section VM7 includes the coil bobbin VM71 having the outer peripheral surface around which the wire VM73 is wound. The magnet section VM8 is configured in a cylindrical shape along the disposed circumferential direction around the central axis Cx of the coil bobbin VM71.

One of the coil section VM7 and the magnet section VM8 moves relative to the other along the central axis Cx. Specifically, the coil section VM7 relatively moves in the +D1 direction along the central axis Cx with respect to the magnet section VM8.

According to such a configuration, since the coil section VM7 and the magnet section VM8 are configured in a cylindrical shape or columnar shape, it is possible to increase the sliding stability of the coil section VM7.

### Modification of Fifth Embodiment

A coating layer similar to the coating layer VM4 may be formed on the contact surface VM74 of the coil section VM7, and a coating layer similar to the coating layer VM4 may be formed on the contact surface VM84 of the magnet section VM8. Alternatively, the plating layer VM6 may be formed on the contact surface VM84.

The coil section VM7 may have a contacted member similar to the contacted member VM25. In this case, the contact surface VM74 may be configured by the contacted member. Similarly, the magnet section VM8 may have a contacted member similar to the contacted member VM25. In this case, the contact surface VM84 may be configured by the contacted member.

### Sixth Embodiment

Next, a sixth embodiment of the present disclosure will be described.

A projector according to the present embodiment is an electronic device to which the actuators AC1 to AC5 according to the first to fifth embodiments can be applied. That is an projector according to the present embodiment is an application example of the actuators AC1 to AC5. Note that in the following description, the same or substantially the same parts as those described above are denoted by the same reference symbols and the description thereof will be omitted.

### Configuration of Projector

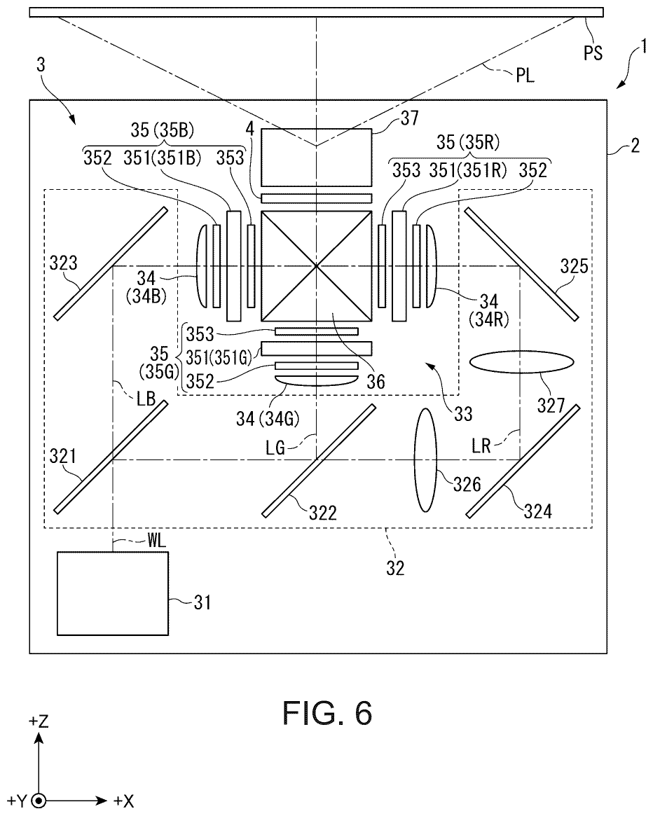

FIG. 6 is a schematic view showing a projector 1 according to the present embodiment.

The projector 1 according to the present embodiment is an electronic device that modulates light emitted from a light source to form image light PL corresponding to image information and projects the formed image light PL onto a projection surface PS. As shown in FIG. 6, the projector 1 includes an exterior housing 2 and an image projection device 3 disposed in the exterior housing 2. Although drawing is omitted, the projector 1 further includes a control device that controls the operation of the projector 1, a power supply device that supplies electric power to the electronic components of the projector 1, and a cooling device that cools a cooling target included in the projector 1.

### Configuration of Image Projection Device

The image projection device 3 forms and projects the image light PL. The image projection device 3 includes a light source device 31, a color separation device 32, an image forming device 33, a projection optical device 37, and an optical path changing device 4. Note that in the following description, a direction in which the light source device 31 emits the illumination light WL is defined as a +Z direction, and directions orthogonal to the +Z direction are defined as +X direction and +Y direction. The direction opposite to the +Z direction is defined as a −Z direction, the direction opposite to the +X direction is defined as a −X direction, and the direction opposite to the +Y direction is defined as a −Y direction. An axis along the +Z direction is a Z-axis, an axis along the +X direction is an X-axis, and an axis along the +Y direction is a Y-axis.

### Configuration of Light Source Device

The light source device 31 emits the illumination light WL in the +Z direction. As the configuration of the light source device 31, a configuration including a solid-state light emitting element as the light source and a wavelength conversion element that converts the wavelength of light emitted from the solid-state light emitting element can be exemplified. Alternatively, as the configuration of the light source device 31, a configuration including a discharge lamp as the light source can be exemplified.

### Configuration of Color Separation Device

The color separation device 32 separates the illumination light WL incident from the light source device 31 into three color light beams of blue light LB, green light LG, and red light LR. The color separation device 32 includes dichroic mirrors 321 and 322, total reflecting mirrors 323, 324, and 325, and relay lenses 326 and 327.

Of the illumination light WL incident from the light source device 31, the dichroic mirror 321 transmits the blue light LB and reflects the green light LG and the red light LR in the +X direction.

Of the green light LG and the red light LR separated by the dichroic mirror 321, the dichroic mirror 322 reflects the green light LG in the +Z direction, and transmits the red light LR in the +X direction. The green light LG reflected by the dichroic mirror 322 is incident on a green light modulation module 35G included in the image forming device 33.

The total reflecting mirror 323 reflects the blue light LB transmitted through the dichroic mirror 321 in the +X direction. The blue light LB reflected by the total reflecting mirror 323 enters a blue light modulation module 35B included in the image forming device 33.

The total reflecting mirror 324 reflects the red light LR transmitted through the dichroic mirror 322 in the +Z direction.

The total reflecting mirror 325 reflects the red light LR reflected by total reflecting mirror 324 in the −X direction. The red light LR reflected by the total reflecting mirror 325 is incident on a red light modulation module 35R included in the image forming device 33.

The relay lens 326 is disposed between the dichroic mirror 322 and the total reflecting mirror 324 in an optical path of red light LR, and the relay lens 327 is disposed between the total reflecting mirror 324 and the total reflecting mirror 325 in the optical path of red light LR. The relay lenses 326 and 327 compensate for the optical loss of the red light LR due to the optical path of the red light LR being longer than an optical path of the blue light LB and an optical path of the green light LG.

### Configuration of Image Forming Device

The image forming device 33 individually modulates the incident blue light LB, green light LG, and red light LR, and combines the modulated color lights LB, LG, and LR to form the image light PL projected by the projection optical device 37. The image forming device 33 includes field lenses 34, light modulation modules 35, and a light synthesis element 36.

### Configuration of Field Lens

The field lenses 34 collimate the incident light. The image forming device 33 includes three field lenses 34. The three field lenses 34 include a field lens 34B provided in the optical path of the blue light LB, a field lens 34G provided in the optical path of the green light LG, and a field lens 34R provided in the optical path of the red light LR. The colored light LB, LG, and LR that passed through the field lenses 34R, 34G, and 34B is incident on the light modulation modules 35 that are provided according to the colored light.

### Configuration of Light Modulation Module

The light modulation modules 35 modulate the incident color light to form image light corresponding to image information and emit the formed image light to the light synthesis element 36. The image forming device 33 includes three light modulation modules 35. The three light modulation modules 35 include the blue light modulation module 35B that modulates the blue light LB and emits blue image light, the green light modulation module 35G that modulates the green light LG and emits green image light, and the red light modulation module 35R that modulates the red light LR and emits red image light.

Each light modulation module 35 includes a light modulation element 351, an incident side polarizing plate 352, and an emission side polarizing plate 353.

Specifically, the blue light modulation module 35B has a blue light modulation element 351B for modulating the blue light LB, an incident side polarizing plate 352 disposed on the light incident side with respect to the blue light modulation element 351B, and an emission side polarizing plate 353 disposed on a light emitting side with respect to the blue light modulation element 351B. The blue light modulation module 35B emits blue image light in the +X direction.

The green light modulation module 35G includes a green light modulation element 351G for modulating the green light LG, the incident side polarizing plate 352, and the emission side polarizing plate 353. The green light modulation module 35G emits green image light in the +Z direction.

The red light modulation module 35R includes a red light modulation element 351R for modulating the red light LR, the incident side polarizing plate 352, and the emission side polarizing plate 353. The red light modulation module 35R emits red image light in the −X direction.

Note that in the present embodiment, the light modulation element 351 is configured by a liquid crystal panel, and each light modulation module 35 is a liquid crystal light valve having the light modulation element 351, the incident side polarizing plate 352, and the emission side polarizing plate 353.

### Configuration of Light Synthesis Element

The light synthesis element 36 combine the blue image light incident from the blue light modulation module 35B, the green image light incident from the green light modulation module 35G, and the red image light incident from the red light modulation module 35R to form the image light PL, and emits the formed image light PL toward the optical path changing device 4. That is, the light synthesis element 36 emits the formed image light PL toward the projection optical device 37.

In the present embodiment, the light synthesis element 36 is configured by a cross dichroic prism having a substantially rectangular parallelepiped shape. However, it is not limited to this, and the light synthesis element 36 may be configured by a plurality of dichroic mirrors.

### Configuration of Projection Optical Device

The projection optical device 37 projects the image light PL incident from the light synthesis element 36 of the image forming device 33 via the optical path changing device 4 onto the projection surface PS. Although drawing is omitted, the projection optical device 37 can be exemplified by a lens assembly including a plurality of lenses and a lens barrel that holds the plurality of lenses.

Note that in the present specification, an image formed by the image light PL projected by the projection optical device 37 and displayed on the projection surface PS is referred to as a projection image.

### Configuration of Optical Path Changing Device

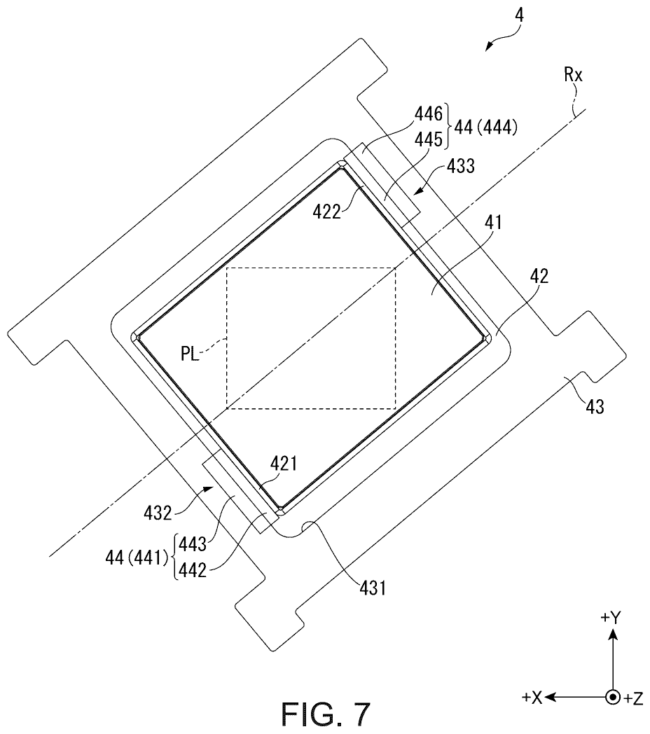

FIG. 7 is a view of the optical path changing device 4 as viewed from the light emitting side.

The optical path changing device 4 shifts the optical path of the image light PL incident on the optical path changing device 4. The optical path changing device 4, as shown in FIG. 7, includes an optical path changing member 41, a movable frame 42, a support frame 43, and drive sections 44.

The optical path changing member 41 is configured by a translucent member that allows the image light to pass through. The optical path changing member 41 is configured by, for example, a glass plate.

### Configuration of Movable Frame

The movable frame 42 is a frame-shaped member that holds the optical path changing member 41 and magnet sections 442 and 445 of the drive section 44.

The movable frame 42 includes a first fixing section 421 to which the magnet section 442 (to be described later) of a first actuator 441, which configures the drive section 44, is fixed, and a second fixing section 422 to which the magnet section 445 (to be described later) of a second actuator 444, which configures the drive section 44, is fixed. The first fixing section 421 and the second fixing section 422 are provided on sides opposite to each other across the swing axis Rx.

### Configuration of Support Frame

The support frame 43 is a frame-shaped member that swingingly supports the movable frame 42 with respect to the swing axis Rx. That is, the support frame 43 supports the movable frame 42 via the swing axis Rx. The support frame 43 has an opening section 431 in which the movable frame 42 is disposed.

The support frame 43 includes a first support section 432 that supports a coil section 443 (to be described later) of the first actuator 441 constituting the drive section 44 and a second support section 433 that supports a coil section 446 (to be described later) of the second actuator 444, which configures the drive section 44. The first support section 432 and the second support section 433 are provided on sides opposite to each other across the swing axis Rx.

### Configuration of Drive Section

The drive section 44 swings the movable frame 42, which holds the optical path changing member 41, with respect to the swing axis Rx relative to the support frame 43, thereby swinging the optical path changing member 41 with respect to the swing axis Rx, and thus shifting the optical path of the image light PL passing through the optical path changing member 41. The drive section 44 has the first actuator 441 provided in the +X direction and the −Y direction with respect to the optical path changing member 41, and the second actuator 444 provided in the −X direction and the +Y direction with respect to the optical path changing member 41.

The first actuator 441 is a voice coil motor having the magnet section 442 fixed to the first fixing section 421 of the movable frame 42 and the coil section 443 supported by the first support section 432 of the support frame 43.

The second actuator 444 is a voice coil motor having the magnet section 445 fixed to the second fixing section 422 of the movable frame 42 and the coil section 446 supported by the second support section 433 of the support frame 43.

By supplying the alternating current of opposite phases to the coil section 443 of the first actuator 441 and the coil section 446 of the second actuator 444, the control device (not shown) causes the optical path changing member 41, held in the movable frame 42, to swing relative to the swing axis Rx.

Note that in the optical path changing device 4, the swing axis Rx of the optical path changing member 41 is perpendicular to the Z-axis and extends in a direction intersecting with both the X-axis and the Y-axis.

Specifically, the intersection angle between the swing axis Rx and the X-axis is the same as the intersection angle between the diagonal line of the image with an aspect ratio of 16:9 and a horizontal direction of the image, and the intersection angle between the swing axis Rx and the Y-axis is the same as the intersection angle between the diagonal line of the image with an aspect ratio of 16:9 and a vertical direction of the image. However, it is not limited to this, for example, the intersection angle between the swing axis Rx and the X-axis, and the intersection angle between the swing axis Rx and the Y-axis, may each be 45°.

The actuators 441 and 444 can adopt the actuator AC1 as described above. When the actuator AC1 is adopted as the first actuator 441, the magnet section VM3 constitutes the magnet section 442 and the coil section VM2 configures the coil section 443. Similarly, when the actuator AC1 is adopted as the second actuator 444, the magnet section VM3 constitutes the magnet section 445 and the coil section VM2 configures the coil section 446.

Here, the magnet section 442 and the coil section 443 are opposed to each other in a direction parallel to the swing axis Rx. The magnet section 445 and the coil section 446 are opposed to each other in a direction parallel to the swing axis Rx. Therefore, when the actuators 441 and 444 operate and the movable frame 42 swings around the swing axis Rx, the magnet section 442, configured by the magnet section VM3, moves in a state of being in contact with the coil section 443, configured by the coil section VM2, and the magnet section 445, configured by the magnet section VM3, moves in a state of being in contact with the coil section 446, configured by the coil section VM2.

Note that instead of the actuator AC1, any one of the actuators AC2 to AC5 according to the second to fifth embodiments may be adopted as the first actuator 441. Similarly, instead of actuator AC1, any one of the actuators AC2 to AC5 according to the second to fifth embodiments may be adopted as the second actuator 444.

### Optical Path Shift by Optical Path Changing Device

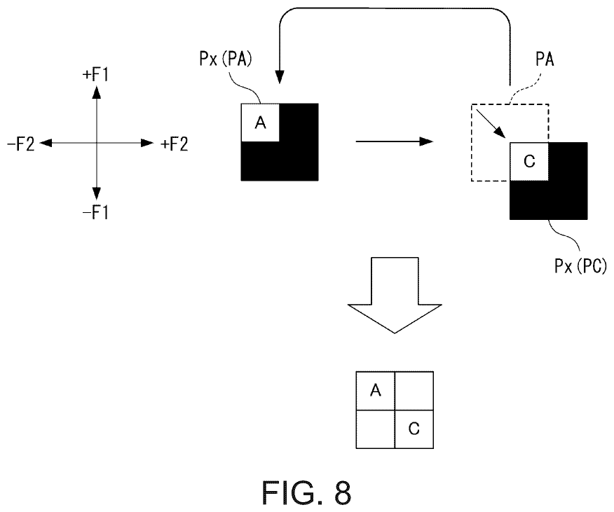

FIG. 8 is a view for explaining the optical path shift of the image light by the optical path changing device 4.

Here, the enhancement of the resolution of the projection image by the optical path changing device 4 will be described.

As described above, by changing the posture of the optical path changing member 41 through which the image light PL is transmitted, the optical path changing device 4 shifts the optical path of the image light PL using refraction in the optical path changing member 41.

Note that a +F1 direction and a +F2 direction shown in FIG. 8 are directions perpendicular to each other on the projection surface PS, a −F1 direction is the opposite direction of the +F1 direction, and a −F2 direction is the opposite direction of the +F2 direction.

Specifically, the optical path changing device 4 swings the optical path changing member 41 around the swing axis Rx to shift the optical path of the image light in a direction orthogonal to the swing axis Rx as viewed from the incident side of the image light with respect to the optical path changing device 4. As a result, as shown in FIG. 8, a pixel Px of the projection image displayed on the projection surface PS is shifted in the +F1 direction and the −F2 direction, which are the directions of shifting to the position PA, and in the −F1 direction and the +F2 direction, which are the directions of shifting to the position PC.

The control device increases the apparent number of pixels and enhances the resolution of the projection image by combining the shift of the pixel Px in the +F1 direction and the −F2 direction with the shift of the pixel Px in the −F1 direction and the +F2 direction by the optical path changing device 4.

For example, by shifting the optical path of the image light by the optical path changing device 4, the control device moves the pixel Px to a position shifted by half a pixel in each of the −F1 direction and the +F2 direction. Note that the half pixel indicates a half size of the pixel Px.

As a result, the display position of the pixel Px on the projection surface PS is shifted to a position PC shifted by half a pixel in the −F1 direction and the +F2 direction from the position PA as the reference position.

As described above, the control device shifts the optical path of the image light PL by the optical path changing device 4 so that the pixel Px is displayed at each of the positions PA and PC for a predetermined time and changes the display content by each of the light modulation modules 35R, 35G, and 35B in synchronization with the optical path shift. As a result, it is possible to display pixels A and C with a size smaller than that of pixel Px in appearance.

For example, for the pixels A and C, when displaying at an overall frequency of 60 Hz, it is necessary to switch the display of each light modulation element 351R, 351G, and 351B at twice the speed of 60 Hz, corresponding to positions PA and PC.

In this case, the refresh rate of each light modulation element 351 is set to 120 Hz, and each light modulation element 351 sequentially forms the image light including the pixel A displayed at position PA and the image light including the pixel C displayed at position PC, whereby a projection image with a high apparent resolution can be displayed.

In the example of the optical path shift shown in FIG. 8, the +F1 direction and the +F2 direction are the arrangement directions of the pixel Px displayed in a matrix on the projection surface PS. The directions in which the pixel Px are moved by swinging the optical path changing member 41 with respect to the swing axis Rx are the −F1 direction and the +F2 direction and the +F1 direction and the −F2 direction, that is, directions intersecting with the +F1 direction and the +F2 direction. Therefore, by swinging the optical path changing member 41 with respect to the swing axis Rx, the pixel Px can be moved to the positions PA and PC.

Note that the amount of deviation of position PC with respect to position PA is not limited to half a pixel, for example, it may be a size of ¼ of the pixel Px, or it may be a size of ¾ of the pixel Px.

### Effects of Sixth Embodiment

The projector 1 according to the present embodiment described above has the following effects.

The projector 1 as the electronic device includes the actuators 441 and 444, each having any of the voice coil motors VM1A, VM1B, VM1C, VM1D, or VM1E.

According to such a configuration, the same effects as those of the voice coil motors VM1A, VM1B, VM1C, VM1D, and VM1E can be achieved. As a result, since the thrust of the voice coil motor can be maintained even when the electric power is reduced, it is possible to achieve power saving of the actuators 441 and 444, and thus the projector 1. On the other hand, even when the thrust of the voice coil motor is maintained, it is possible to reduce the size of the voice coil motor, and thus it is possible to reduce the size of the actuators 441 and 444, and the size of projector 1.

The projector 1 is provided with the light source device 31 that includes the light source and the optical path changing device 4 that changes the optical path of the light flux emitted from the light source device 31. That is, the projector 1 includes the light source and the optical path changing device 4 that changes the optical path of light emitted from the light source.

The optical path changing device 4 includes the movable frame 42 that holds the optical path changing member 41, the support frame 43 that supports the movable frame 42 via the swing axis Rx, and the actuators 441 and 444 that swing the movable frame 42 with respect to the support frame 43 around the swing axis Rx. The actuators 441 and 444 have one of the voice coil motors VM1A, VM1B, VM1C, VM1D, and VM1E.

The coil sections 443 and 446 of the actuators 441 and 444 are disposed on one of the movable frame 42 and the support frame 43. Specifically, the coil sections 443 and 446 are disposed on the support frame 43 and are configured by, for example, the coil section VM2.

The magnet sections 442 and 445 of the actuators 441 and 444 are disposed on the other one of the movable frame 42 and the support frame 43. Specifically, the magnet sections 442 and 445 are disposed on the movable frame 42 and are configured by, for example, the magnet section VM3.

According to such a configuration, since the thrust of the voice coil motor, and thus the thrust of the actuators 441 and 444 can be increased, the optical path changing member 41 can be stably swung. On the other hand, since it is possible to reduce the size and power consumption of the voice coil motor while maintaining the thrust, it is possible to reduce the size and power consumption of the actuators 441 and 444, and thus, to reduce the size and power consumption of the optical path changing device 4.

In the optical path changing device 4, the magnet section 442 and the coil section 443 are opposed to each other in a direction parallel to the swing axis Rx, and the magnet section 445 and the coil section 446 are opposed to each other in a direction parallel to the swing axis Rx.

According to such a configuration, since the magnet sections 442 and 445 can be easily slid while in contact with the coil sections 443 and 446, the optical path changing member 41 can be easily swung. Therefore, it is possible to stably operate the optical path changing device 4.

### Modification of Embodiment

The present disclosure is not limited to the above embodiments, and modifications and improvements within the scope of attaining the object of the present disclosure are included in the present disclosure.

In each of the above embodiments, among the coil section and the magnet section, one member was moved while in contact with the other member. However, it is not limited to this, and the present disclosure also includes a voice coil motor in which the coil section and the magnet section are separate from each other at least at one timing of stopping timing and operation timing of the voice coil motor. In other words, in the voice coil motor of the present disclosure, the coil section and the magnet section may be separated from each other at least at one timing of stopping timing and operation timing of the voice coil motor.

In each of the above embodiments, among the coil section and the magnet section, one member was set to relatively linear motion with respect to the other member. However, it is not limited to this, and the moving direction of the one member may be a circumferential direction around a predetermined rotation axis. That is, the one member may reciprocally move along a circumferential direction around a predetermined rotation axis.

In this case, the contact surface of one of the coil section side contact surface and the magnet section side contact surface may be formed in an arc shape along the circumferential direction centered on a predetermined rotation axis.

In the above first to fourth and sixth embodiments, the magnet section is set to move relatively to the coil section. In the fifth embodiment, the coil section moves relative to the magnet section. In this way, it is sufficient that a member of one of the coil section and the magnet section moves relatively to the other member, and the one member that moves relatively to the other member may be either the coil section or the magnet section.

In the above first to fourth and sixth embodiments, in the magnet section VM3, the magnetic poles of contact surfaces in contact with the coil sections VM2 and VM2D are different and it includes the first magnet VM32 and the second magnet VM33 which are integrated with each other to form the magnet section VM3. Here, the first magnet VM32 and the second magnet VM33 are directly connected to each other. However, it is not limited to this, and the first magnet VM32 and the second magnet VM33 may be separated from each other by disposing a member between the first magnet VM32 and the second magnet VM33.

In the above second embodiment, the coating agent contains at least one of polytetrafluoroethylene resin, molybdenum disulfide, carbon graphite, or boron nitride. However, the composition of the coating agent is not limited to the above.

In the above third embodiment, the contact surface VM31 of the magnet section VM3 is subjected to plating processing with a material containing at least one of nickel, copper, or tin. However, the plating processing performed on the contact surface VM31 is not limited to the above.

In the above fourth embodiment, the contacted member VM25 includes at least one of polyacetal, polytetrafluoroethylene resin, ultra-high molecular weight polyethylene, monomer cast nylon, or polyacetal resin. However, the composition of the contacted member VM25 is not limited to the above. For example, the contacted member coated with the coating agent may configure the contact surface, or the contacted member subjected to the plating processing may configure the contact surface.

In the above first to fourth embodiments, the magnet section VM3 has the first magnet VM32 and the second magnet VM33 with different magnetic poles on the contact surfaces in contact with the coil section VM2, and the first magnet VM32 and the second magnet VM33 are disposed adjacent to each other in the +D2 directions. However, it is not limited to this, and the magnet section VM3 may be configured by one magnet. The magnet section VM3 may be provided with a plurality of magnets arranged so that the magnetic poles of the contact surface in contact with the coil section VM2 change alternately.

In the above sixth embodiment, the movable frame 42 is provided with the magnet sections 442 and 445, and the support frame 43 is provided with the coil sections 443 and 446. However, it is not limited to this, and the movable frame 42 may be provided the coil sections 443 and 446, and the support frame 43 may be provided the magnet sections 442 and 445.

The actuator of one of the first actuator 441 and the second actuator 444 may not be provided, and another actuator may be provided in the optical path changing device 4.

In the above sixth embodiment, the projector 1 has been exemplified as an electronic device including the actuators AC1 to AC5 having the voice coil motors VM1A, VM1B, VM1C, VM1D, and VM1E. However, it is not limited to this, and the electronic device including the voice coil motor of the present disclosure may be an electronic device other than a projector.

For example, the voice coil motor of the present disclosure may be adopted as a configuration for moving the swing arm of a hard disk device, which is an electronic device. For example, the voice coil motor of the present disclosure may be adopted as a configuration for moving the pickup lens of an optical drive, which is an electronic device. For example, the voice coil motor of the present disclosure may be adopted as a configuration for moving the pendulum of an vibration generating device, which is an electronic device.

In the above sixth embodiment, as the configuration to which any one of the voice coil motors VM1A, VM1B, VM1C, VM1D, and VM1E is applied, the optical path changing device 4 that shifts the optical path of the incident image light PL is exemplified. However, it is not limited to this, and the optical path changing device 4 that shifts the optical path of incident light may be used for other purposes in the projector. For example, when the light source device 31 includes the solid-state light emitting element as the light source and the wavelength conversion element for converting the wavelength of the light emitted from the solid-state light emitting element, the optical path changing device 4 may be adopted to shift the optical path of the light emitted from the solid-state light emitting element and incident on the wavelength conversion element.

### Summary of Present Disclosure

Hereinafter, a summary of the present disclosure will be appended.

### APPENDIX 1

A voice coil motor includes a coil section having a wound wire and a magnet section configured to contact the coil section, wherein a member of one of the coil section and the magnet section is configured to move relative to the other member.

According to such a configuration, since the coil section and the magnet section are in contact with each other, the magnetic efficiency of the voice coil motor can be improved as compared with a case where the coil section and the magnet section are always separated from each other. As a result, the Lorentz force in the voice coil motor can be increased, and the thrust of one of the coil section and the magnet section, which moves relative to the other section, can be increased. On the other hand, when the thrust is the same, it can be made smaller than the voice coil motor of related art.

### APPENDIX 2

A voice coil motor according to Appendix 1, wherein the coil section has a coil section side contact surface, the magnet section has a magnet section side contact surface that is configured to contact with the coil section side contact surface, and the contact surface of at least one of the coil section side contact surface and the magnet section side contact surface is coated with a coating agent.

According to such a configuration, it is possible to reduce the sliding resistance when one member slides relative to the other member. Therefore, it is possible to easily slide the one member with respect to the other member.

### APPENDIX 3

A voice coil motor according to Appendix 2, wherein the coating agent is configured to coat the circumferential surface of the wire.

According to such a configuration, it is not necessary to coat the coil section side contact surface by applying a coating agent to the coil section side contact surface. Therefore, the manufacturing process of the voice coil motor can be simplified.

### APPENDIX 4

The voice coil motor according to Appendixes 2 or 3, wherein the coating agent includes least one of polytetrafluoroethylene resin, molybdenum disulfide, carbon graphite, or boron nitride.

The coating agent containing at least one of a fluorine resin, molybdenum disulfide, carbon graphite, or boron nitride is a coating agent with a low friction coefficient and high wear resistance properties.

Therefore, according to the above configuration, it is possible to impart a low friction coefficient and high wear resistance properties to at least one of the contact surfaces.

### APPENDIX 5

A voice coil motor according to Appendix 1, wherein the magnet section has a magnet section side contact surface that is in contact with the coil section and the magnet section side contact surface is subjected to plating processing with a material containing at least one of nickel, copper, or tin.

According to such a configuration, high lubricity can be imparted by infiltrating the lubricant into the magnet section side contact surface subjected to the plating processing. Therefore, the sliding property of the one member relative to the other member can be improved.

### APPENDIX 6

A voice coil motor according to Appendix 1, wherein the coil section has a coil section side contact surface, the magnet section has a magnet section side contact surface that is configured to contact with the coil section side contact surface, and the contact surface of at least one of the coil section side contact surface and the magnet section side contact surface is configured by a contacted member with which the other contact surface is brought in contact.

According to such a configuration, since at least one contact surface is formed by the contacted member, by configuring the contacted member from a material with high sliding property, the sliding property of one member with respect to the other member can be increased. Therefore, the sliding property of the one member relative to the other member can be improved.

### APPENDIX 7

Voice coil motor according to Appendix 6, wherein the contacted member includes at least one of polyacetal, polytetrafluoroethylene resin, ultra-high molecular weight polyethylene, monomer cast nylon, or polyacetal resin.

Polyacetal, polytetrafluoroethylene resin, ultra-high molecular weight polyethylene, monomer cast nylon, and polyacetal resin are resins having good self-lubricating properties and wear resistance properties.

Therefore, according to the above configuration, it is possible to impart good self-lubricating properties and wear resistance properties to at least one contact surface.

### APPENDIX 8

The voice coil motor according to any one of Appendixes 1 to 7, wherein the magnet section is configured to move relative to the coil section in a direction orthogonal to a central axis of the coil section, the magnet section has a first magnet and a second magnet having different magnetic poles on the contact surfaces that contact the coil section, and the first magnet and the second magnet are disposed adjacent to each other in a direction in which the magnet section moves relative to the coil section.

According to such a configuration, it is possible to reciprocally move the one member along a direction perpendicular to the central axis of the coil section. Therefore, it is possible to stably operate the voice coil motor.

### APPENDIX 9

The voice coil motor according to any one of Appendixes 1 to 7, wherein the coil section has a coil bobbin around which the wire is wound on an outer peripheral surface thereof, the magnet section is configured in a cylindrical shape disposed along a circumferential direction around a central axis of the coil bobbin, and one of the coil section and the magnet section moves along the central axis relative to the other of the coil section and the magnet section.

According to such a configuration, since each of the magnet section and the coil section is configured in a cylindrical shape or columnar shape, it is possible to increase the sliding stability of the one member.

### APPENDIX 10

An electronic device includes the actuator that has the voice coil motor according to any one of Appendices 1 to 9.

According to such a configuration, the same effect as that of the above described voice coil motor can be achieved. As a result, since the thrust of the voice coil motor can be maintained even when the electric power is reduced, it is possible to achieve power saving of the actuator, and thus the electronic device. On the other hand, even if the thrust of the voice coil motor is maintained, the size of the voice coil motor can be reduced, allowing for the miniaturization of the actuator, and thus the electronic device.

### APPENDIX 11

An optical path changing device includes a movable frame configured to hold an optical path changing member; a support frame configured to support the movable frame via a swing axis; and the voice coil motor according to any one of Appendices 1 to 9 configured to cause the movable frame to swing around the swing axis with respect to the support frame, wherein the coil section is disposed on one of the movable frame and the support frame and the magnet section is disposed on the other of the movable frame and the support frame.

According to such a configuration, since the thrust of the voice coil motor can be increased, the optical path changing member 41 can be stably swung. On the other hand, since it is possible to reduce the size and power consumption of the voice coil motor while maintaining the thrust, it is possible to reduce the size and power consumption of the optical path changing device.

### APPENDIX 12

The optical path changing device according to claim 11,
wherein the coil section and the magnet section are opposed to each other in a direction parallel to the swing axis.

According to such a configuration, since one member can be easily slid while being in contact with the other member, the optical path changing member can be easily swung. Therefore, it is possible to stably operate the optical path changing device.

### APPENDIX 13

An electronic device includes a light source device and the optical path changing device according to Appendix 11 or 12 configured to change the optical path of the light flux emitted from the light source device.

According to such a configuration, the same effects as those of the above described optical path changing device can be achieved.

What is claimed is:

1. A voice coil motor comprising:
a coil section having a wound wire and
a magnet section configured to contact the coil section, wherein
a member of one of the coil section and the magnet section is configured to move relative to the other member.

2. The voice coil motor according to claim 1, wherein
the coil section has a coil section side contact surface,
the magnet section has a magnet section side contact surface that is configured to contact with the coil section side contact surface, and
the contact surface of at least one of the coil section side contact surface and the magnet section side contact surface is coated with a coating agent.

3. The voice coil motor according to claim 2, wherein
the coating agent is configured to coat the circumferential surface of the wire.

4. The voice coil motor according to claim 2, wherein
the coating agent includes at least one of polytetrafluoroethylene resin, molybdenum disulfide, carbon graphite, or boron nitride.

5. The voice coil motor according to claim 1, wherein
the magnet section has a magnet section side contact surface that is in contact with the coil section and
the magnet section side contact surface is subjected to plating processing with a material containing at least one of nickel, copper, or tin.

6. The voice coil motor according to claim 1, wherein
the coil section has a coil section side contact surface,
the magnet section has a magnet section side contact surface that is configured to contact with the coil section side contact surface, and
the contact surface of at least one of the coil section side contact surface and the magnet section side contact surface is configured by a contacted member with which the other contact surface is brought in contact.

7. The voice coil motor according to claim 6, wherein
the contacted member includes at least one of polyacetal, polytetrafluoroethylene resin, ultra-high molecular weight polyethylene, monomer cast nylon, or polyacetal resin.

8. The voice coil motor according to claim 1, wherein
the magnet section is configured to move relative to the coil section in a direction orthogonal to a central axis of the coil section,
the magnet section has a first magnet and a second magnet having different magnetic poles on the contact surfaces that contact the coil section, and
the first magnet and the second magnet are disposed adjacent to each other in a direction in which the magnet section moves relative to the coil section.

9. The voice coil motor according to claim 1, wherein
the coil section has a coil bobbin around which the wire is wound on an outer peripheral surface thereof,
the magnet section is configured in a cylindrical shape disposed along a circumferential direction around a central axis of the coil bobbin, and
one of the coil section and the magnet section moves along the central axis relative to the other of the coil section and the magnet section.

10. An electronic device comprising:
an actuator having the voice coil motor according to claim 1.

11. An optical path changing device comprising:
a movable frame configured to hold an optical path changing member;
a support frame configured to support the movable frame via a swing axis; and
the voice coil motor according to claim 1 configured to cause the movable frame to swing around the swing axis with respect to the support frame, wherein
the coil section is disposed on one of the movable frame and the support frame and
the magnet section is disposed on the other of the movable frame and the support frame.

12. The optical path changing device according to claim 11, wherein
the coil section and the magnet section are opposed to each other in a direction parallel to the swing axis.

13. An electronic device comprising:
a light source device and
the optical path changing device according to claim 11 configured to change an optical path of a light flux emitted from the light source device.
